(19) United States
(12) Patent Application Publication
(10) Pub. No.: US 2017/0255381 A1
(43) Pub. Date: Sep. 7, 2017

(54) DISPLAY DEVICE

(71) Applicant: KYOCERA Document Solutions Inc., Osaka (JP)

(72) Inventor: Tomoaki NAKAIZAWA, Osaka-shi (JP)

(73) Assignee: KYOCERA Document Solutions Inc., Osaka (JP)

(21) Appl. No.: 15/443,107

(22) Filed: Feb. 27, 2017

(30) Foreign Application Priority Data
Mar. 2, 2016 (JP) 2016-040116

(51) Int. Cl. G06F 3/0488; G06F 3/0485

(52) U.S. Cl. CPC G06F 3/04883; G06F 3/0485; G06F 2203/04803

(57) ABSTRACT

A display device includes a display surface, a detector, and a controller. The display surface displays an image. The detector detects a gesture toward the display surface. The controller controls the image displayed on the display surface based on the gesture detected by the detector. The display surface includes a first region and a second region located adjacent to the first region. The image includes a first image located over the first and second regions and a second region located in the second region such as to cover a part of the first image. Upon the detector detecting the gesture toward the first region, the controller displays the second image in a translucent manner by increasing transmittance of the second image.

### INCORPORATION BY REFERENCE

The present application claims priority under 35 U.S.C. §119 to Japanese Patent Application No. 2016-040116, filed on Mar. 2, 2016. The contents of this application are incorporated herein by reference in their entirety.

### BACKGROUND

The present disclosure relates to a display device.

A display device has been known that displays soft key images and a part of a scrollable list image side by side in a scrolling direction. The list image is for example an image indicating an address book. When the list image is scrolled, the soft key images are not displayed so that a region of a display surface in which the list image is displayed is enlarged.

### SUMMARY

A display device according to the present disclosure includes a display surface, a detector, and a controller. The display surface displays an image. The detector detects a gesture toward the display surface. The controller includes a processing circuit that controls the image displayed on the display surface based on the gesture detected by the detector through execution of programs stored in a storage section. The display surface includes a first region and a second region. The second region is located adjacent to the first region. The image includes a first image and a second image. The first image is located over the first and second regions. The second image is located in the second region such as to cover a part of the first image. Upon the detector detecting a gesture toward the first region, the controller displays the second image in a translucent manner by increasing transmittance of the second image.

Another display device according to the present disclosure includes a display surface, a detector, and a controller. The display surface displays an image. The detector detects a gesture toward the display surface. The controller includes a processing circuit that controls the image displayed on the display surface based on the gesture detected by the detector through execution of programs stored in a storage section. The display surface includes first region and a second region. The second region is located adjacent to the first region. The image includes a first image and a second image. The first image is located over the first and second regions. The second image is located in the second region such as to cover a part of the first image. Upon the detector detecting the gesture toward the first region, the controller scrolls the first image while causing the display surface to display the second image in a transparent manner by increasing transmittance of the second image up to 100%.

### BRIEF DESCRIPTION OF THE DRAWINGS

FIG. 1 is a front view of a display device according to an embodiment of the present disclosure.

FIG. 2 is a block diagram illustrating configuration of the display device in FIG. 1.

FIG. 3 illustrates a state in which a first image is scrolled.

FIG. 4A illustrates the display device directly after scrolling of the list image stops. FIG. 4B illustrates the display device before a predetermined time period elapses after scrolling of the list image stops. FIG. 4C illustrates the display device when the predetermined time period elapses after scrolling of the list image stops.

FIG. 5 is a flowchart depicting operation of scrolling of the first image by a controller.

FIG. 6A illustrates the display device directly before the list image is inertially scrolled. FIG. 6B illustrates the display device before a predetermined first time period elapses after the list image is inertially scrolled. FIG. 6C illustrates the display device when the predetermined first time period elapses after the list image is inertially scrolled.

FIG. 7 is a flowchart depicting operation of inertial scrolling of the first image by the controller.

### DETAILED DESCRIPTION

The following explains embodiments of the present disclosure with reference to the accompanying drawings. However, the present disclosure is not limited to the following embodiments. Elements in the drawings that are the same or equivalent are marked by the same reference signs. Furthermore, explanation of such elements is not repeated.

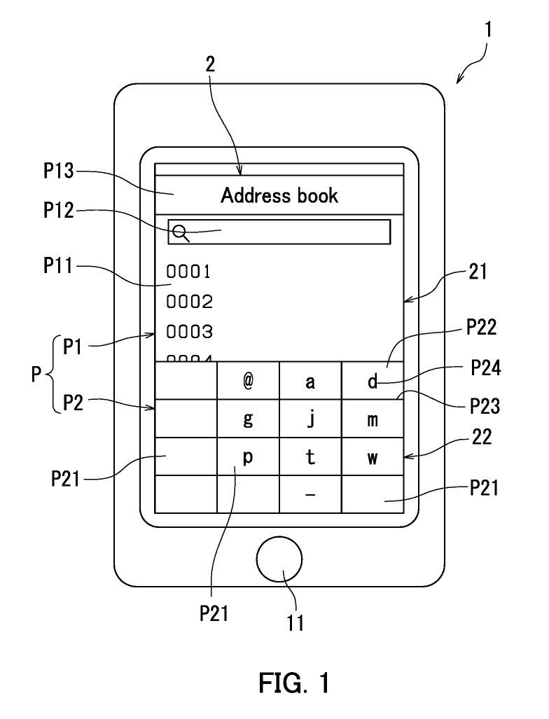

FIG. 1 is a front view of a display device 1 according to the present embodiment. As illustrated in FIG. 1, the display device 1 includes a display surface 2. The display device 1 according to the present embodiment is applied to for example a smartphone having a telephone function and a mail function. Note that the smartphone may include a hard key 11. The hard key 11 may for example be a start key or an enter key.

The display surface 2 displays an image P. The display surface 2 is constituted by for example a liquid-crystal display. The display surface 2 includes a first region 21 and a second region 22. The second region 22 is located adjacent to the first region 21. The first and second regions 21 and 22 are adjacent to each other for example in an up-and-down direction.

The image P includes a first image P1 and a second image P2. The first image P1 is located over the first and second regions 21 and 22. The second image P2 is located in the second region 22 such as to cover a part of the first image P1.

The first image P1 is scrollable for example in the up-and-down direction. The first image P1 includes a list image P11 such as an address book. The list image P11 in the present embodiment is an image indicating a plurality of addresses 0001, 0002, . . . aligned in the up-and-down direction.

The second image P2 includes a plurality of soft key images P21 and contour lines P23. The second image P2 in the present embodiment is for receiving for example input of a search word by a user searching a desired address. The contour lines P23 each are an image indicating a line segmenting adjacent soft key images P21. The contour lines P23 are colored in a predetermined color. The soft key images P21 each include a background image P22 and a character image P24. The background image P22 is colored in a color different from that of the contour lines P23. The character image P24 is an image indicating a character such as an alphabet or a sign such as an at mark that is located at the center of a corresponding one of the soft key images P21. The character image P24 is colored in a color different from that of the background image P22.

Note that the image P may further include an input field image P12 and a title field image P13. The input field image P12 displays a search word input by a user using any of the soft key images P21. The title field image P13 displays a title of the first image P1.

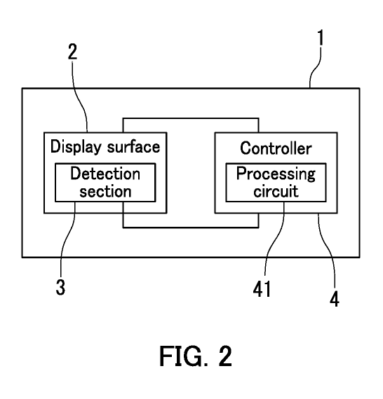

FIG. 2 is a block diagram illustrating configuration of the display device 1. As illustrated in FIG. 2, the display device 1 further includes a detector 3 and a controller 4. Description will be made next about respective configurations of the detector 3 and the controller 4 with reference to FIGS. 1 and 2.

The detector 3 detects a gesture toward the display surface 2. The detector 3 generates signals corresponding to the detected gesture and inputs the generated signals to the controller 4. Specifically, the detector 3 detects a gesture toward the display surface 2 and generates signals corresponding to the gesture. In the above configuration, a user can provide various types of instructions to the controller 4 by making gestures.

The configuration of the detector 3 is not limited specifically in the present embodiment so long as the detector 3 can detect a gesture. For example, the detector 3 may be an electrostatic capacitive touch sensor, a resistive film touch sensor, or a ultrasonic touch sensor. In a configuration in which the detector 3 is a touch sensor, the detector 3 is disposed on the display surface 2.

Examples of the gesture in the present embodiment include a scrolling gesture and a momentum scrolling gesture. Note that the gesture may further include a tapping gesture. The tapping gesture is an operation of tapping the display surface 2. A user makes the tapping gesture in a manner to lightly tap the display surface 2 using a finger.

The scrolling gesture is a gesture of sliding a finger touching the display surface to cause scrolling of the first image P1. The user makes a scrolling gesturer in a manner to slide a finger touching the display surface 2 in a scrolling direction. The scrolling gesture toward the list image P11 provides to the controller 4 an instruction to scroll the list image P11. Note that the list image P11 is scrolled according to sliding speed and direction of the finger.

The momentum scrolling gesture causes scrolling of the first image P1 even after the figure touching the display surface 2 is removed from the display surface 2. The momentum scrolling gesture is a gesture of for example quickly scrolling the list image P11 and removing the finger from the display surface 2. The momentum scrolling gesture toward the list image P11 provides to the controller 4 an instruction to continue inertial scrolling of the list image P11 even after the finger is removed from the display surface 2. Note that speed, direction, and duration of inertial scrolling of the list image P11 vary according to speed, direction, and distance of the finger sliding in the momentum gesture.

The controller 4 includes a processing circuit 41 that performs various processing such as numeric calculation, information processing, and device control through execution of pre-stored programs. The detector 3 generates signals according to a user gesture. The controller 4 controls the image P displayed on the display surface 2 according to the signals generated by the detector 3.

Note that the processing circuit 41 of the controller 4 in the present embodiment includes an application specific integrated circuit (ASIC) for image processing or a processor such as a central processing unit (CPU) or a micro processing unit (MPU).

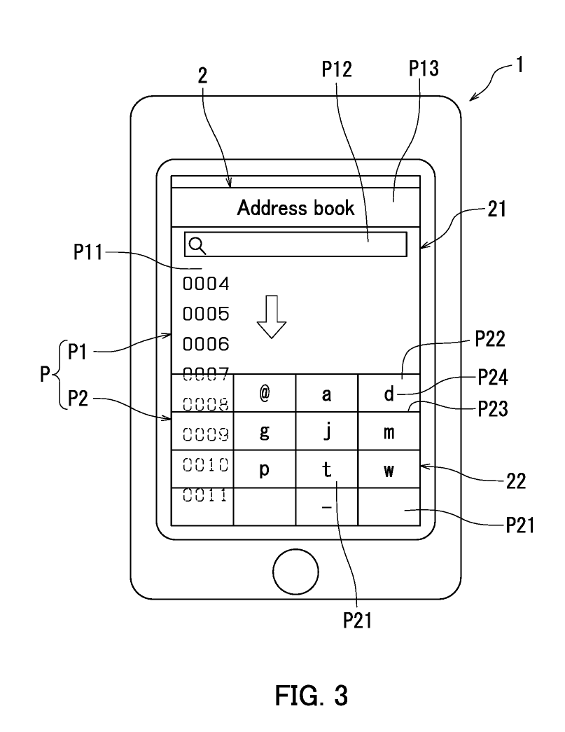

FIG. 3 illustrates scrolling of the list image P11. As illustrated in FIG. 3, once a gesture toward the first region 21 is detected, the controller 4 increases the transmittance of the soft key images P21. The controller 4 in the present embodiment increases the transmittance of the soft key images P21 upon detection of a gesture toward the list image P11. The soft key images P21 increased in transmittance are displayed in a translucent manner. Upon detection of the gesture toward the first region 21, the controller 4 increases the transmittance of the soft key images P21. As a result, the transmittance of the second image P2 is increased. The second image P2 increased in transmittance is translucent. Note that addresses 0007 to 0011 are depicted by broken lines in FIG. 3 in order to demonstrate that the soft key images P21 are translucent.

When the second image P2 is displayed in a translucent manner, the list image P11 is displayed in the second region 22 in addition to the soft key images P21. Through the above, the user can visibly check the list image P11 together with the soft key images P21 in the second region 22. As a result, the user can check much more address information contained in the list image P11, thereby reducing time taken to obtain desired information. Furthermore, in a situation in which search words are successively input, it is unnecessary for a user to cause the soft key images P21 to be re-displayed, thereby suppressing an increase in operation frequency. As a result, much more information can be displayed and an increase in operation frequency can be suppressed in the display device 1.

The controller 4 in the present embodiment changes the transmittance of only the background images P22 of the respective soft key images P21 for displaying the soft key images P21 in a translucent manner. The second image P2 is accordingly displayed in a translucent manner. The term “translucent” means a state in which an address included in the list image P11 is displayed in a visible manner together with the contour lines P23 and the character images P24. The transmittance of the soft key images P21 is set greater than 0% and less than 100%.

The controller 4 increases the transmittance of the soft key images P21 to a specific transmittance and keeps the transmittance thereof at the specific transmittance in the course of detection of scrolling. The controller 4 increases the transmittance of the soft key images P21 to the specific transmittance and keeps the transmittance thereof at the specific transmittance in the course of detection of scrolling to increase the transmittance of the second image P2 and keep the transmittance thereof at the specific transmittance. In the above configuration, the soft key images P21 are kept displayed in a translucent manner at the specific transmittance during the user continuing the scrolling gesture. As a result, the user can check the soft key images P21 and the list image P11 in the second region 22 further positively for duration of the scrolling gesture and time taken to obtain desired information can be further reduced. Note that the specific transmittance is preferably a transmittance at which a user can visually check the soft key images P21 and the list image P11 in the second region 22 in the most effortless manner. The specific transmittance can be determined for example through an experiment.

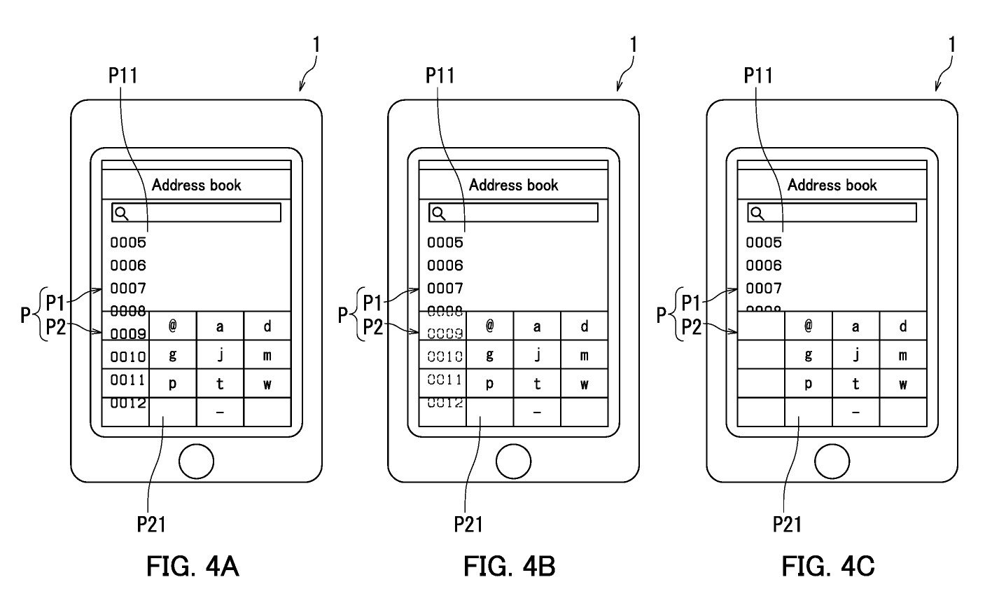

FIGS. 4A to 4C each illustrate the display surface 2 in which scrolling of the list image P11 stops. Specifically, FIG. 4A illustrates the display device 1 directly after scrolling of the list image P11 stops. FIG. 4B illustrates the display device 1 before a predetermined time period elapses after scrolling of the list image P11 stops. FIG. 4C illustrates the display device 1 when the predetermined time period elapses after scrolling of the list image P11 stops. Note that addresses 0008 to 0012 are depicted by broken lines in FIG. 4B in order to demonstrate that the soft key images P21 are translucent.

Once the scrolling gesture is not detected, the controller 4 stops scrolling the list image P11, as illustrated in FIG. 4A.

After scrolling stops, the controller 4 gradually reduces the transmittance of the soft key images P21 for the predetermined time period, as illustrated in FIG. 4. The controller 4 gradually reduces the transmittance of the soft key images P21 for the predetermined time period to gradually reduce the transmittance of the second image P2. Note that the predetermined time period is determined in view of time taken for a user to visually check a part of the list image P11 underlying the soft key images P21. The predetermined time period is set for example at one to two seconds.

When the predetermined time period elapses, the controller 4 further reduces the transmittance of the soft key images P21, as illustrated in FIG. 4C. The transmittance of the soft key images P21 is reduced for example to 0%. When the predetermined time period elapses, the controller 4 reduces the transmittance of the soft key images P21 to reduce the transmittance of the second image P2 for example to 0%. In the above configuration, the user having obtained desired information from the list image P11 can make a taping gesture toward any of the soft key images P21 further easily. Note that the controller 4 may reduce the transmittance of the soft key images P21 to 0% directly after stop of scrolling of the list image P11. In other words, the controller 4 may reduce the transmittance of the second image P2 by reducing the transmittance of the soft key images P21 directly after stop of scrolling of the list image P11.

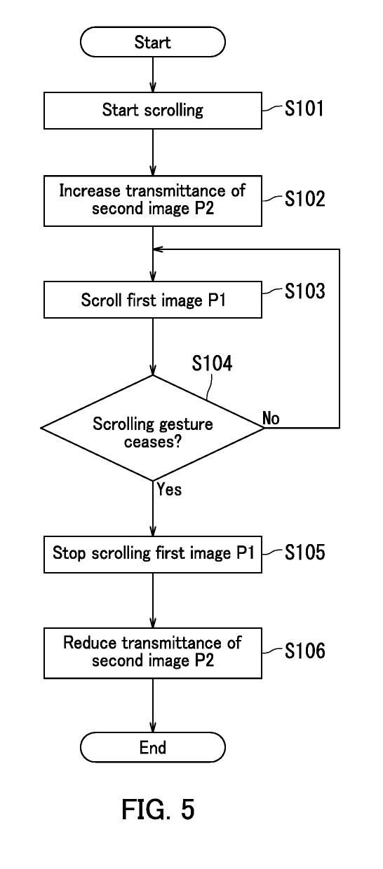

With reference to FIGS. 3-5, a description will be made next about operation by the controller 4 in a situation in which the detector 3 detects a scrolling gesture. FIG. 5 is a flowchart depicting operation of scrolling of the first image P1 by the controller 4. The present embodiment describes operation by the controller 4 in a situation in which a scrolling gesture is made toward the list image P11.

First, the controller 4 receives signals for scrolling from the detector 3 at Step S101. Subsequently, the controller 4 increases the transmittance of the second image P2 to the specific transmittance to display the second image P2 in a translucent manner in the second region 22 at Step S102. As a result, a part of the list image P11 is visibly displayed in the second region 22 together with the soft key images P21.

At Step S103, the controller 4 measures speed and direction of the scrolling gesture. The controller 4 then scrolls the list image P11 in correspondence with a user's finger sliding on the display surface 2.

Next at Step S104, the controller 4 determines whether or not the signals for scrolling are continuously input. When it is determined that the signals for scrolling are continuously input, the routine returns to Step S103 and the controller 4 scrolls the list image P11 in response to the signals. By contrast, when it is determined that the signals are not received, the controller 4 stops scrolling the list image P11 at Step S105.

The controller 4 gradually reduces the transmittance of the soft key images P21 at Step S106. Once the predetermined time period elapses, the controller 4 sets the transmittance of the soft key images P21 at 0% and the processing ends. Note that at Step S106, the controller 4 may reduce the transmittance of the soft key images P21 to 0% and the processing may end regardless of elapsed time.

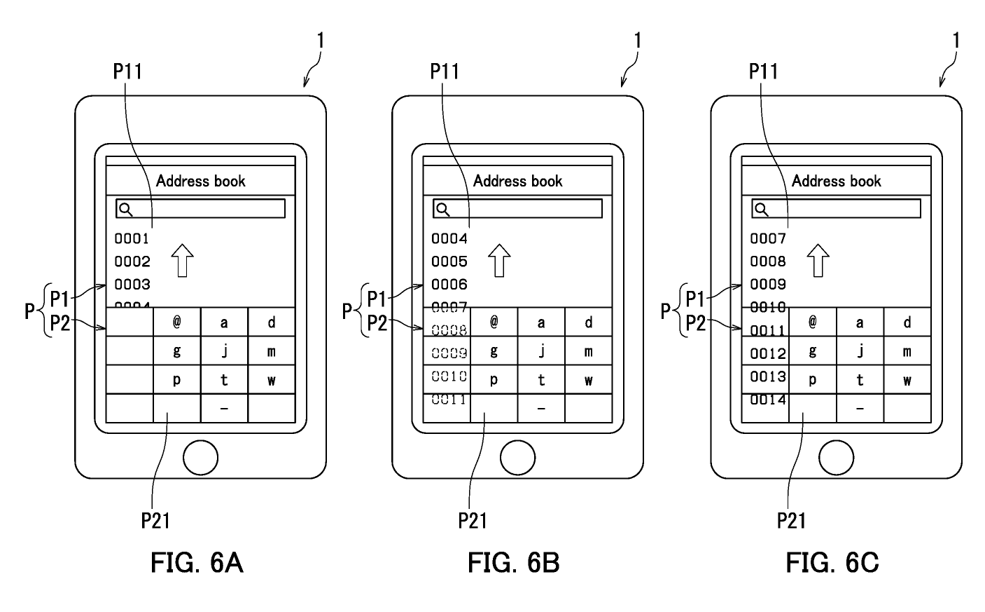

FIGS. 6A to 6C each illustrate the display surface 2 in a state in which the list image P11 is inertially scrolled. Specifically, FIG. 6A illustrates the display device 1 directly before the list image P11 is scrolled in response to a momentum scrolling gesture. FIG. 6B illustrates the display device 1 before a predetermined first time period elapses after the list image P11 is scrolled in response to the momentum scrolling gesture. FIG. 6C illustrates the display device 1 when the predetermined first time period elapses after the list image P11 is scrolled in response to the momentum scrolling gesture. Note that addresses 0007 to 0011 are depicted by broken lines in FIG. 6B in order to demonstrate that the soft key images P21 are translucent.

As illustrated in FIG. 6A, the controller 4 in the present embodiment scrolls the list image P11 upon detection of a momentum scrolling gesture. The present embodiment describes a situation in which a momentum scrolling gesture from below to above (see arrows in the drawings) toward the list image P11 is detected and the list image P11 is scrolled from below to above.

As illustrated in FIG. 6B, when the momentum scrolling gesture is detected, the controller 4 gradually increases the transmittance of the soft key images P21 for the predetermined first time period. The controller 4 gradually increases the transmittance of the soft key images P21 for the predetermined first time period to gradually increase the transmittance of the second image P2. The soft key images P21 increased in transmittance are displayed in the second region 22 in a translucent manner. As a result, much more addresses can be displayed in inertial scrolling of the list image P11 and time taken for a user to obtain desired information can be reduced. Furthermore, it is unnecessary for a user to cause the soft key images P21 to be re-displayed in order to input a search word, thereby suppressing an increase in operation frequency.

As illustrated in FIG. 6C, when the predetermined first time period elapses, the controller 4 sets the transmittance of the soft key images P21 at the highest transmittance. Note that the predetermined first time period is determined in view of time taken to cause inertial scrolling of the list image P11. The predetermined first time period is set for example at one to two seconds.

The controller 4 continues scrolling the list image P11 for a specific time period in response to the momentum scrolling gesture and then stops scrolling the list image P11. Once scrolling of the list image P11 stops, the controller 4 gradually reduces the transmittance of the soft key images P21 for a predetermined second time period. The controller 4 gradually reduces the transmittance of the soft key images P21 for the predetermined second time period to gradually reduce the transmittance of the second image P2. When the predetermined second time period elapses, the controller 4 sets the transmittance of the soft key images P21 at 0%. The controller 4 sets the transmittance of the soft key images P21 at 0% to set the transmittance of the second image P2 at 0%.

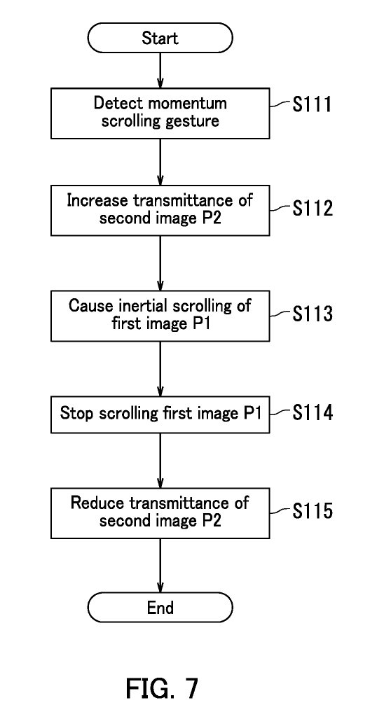

Description will be made next with reference to FIGS. 6A-7 about operation by the controller 4 in a situation in which the detector 3 detects a momentum scrolling gesture. FIG. 7 is a flowchart depicting operation by the controller 4 in inertial scrolling of the first image P1. The present embodiment describes operation by the controller 4 in a situation in which a momentum scrolling gesture is made toward the list image P11.

First, the controller 4 receives signals for inertial scrolling from the detector 3 at Step S111. Subsequently, the controller 4 increases the transmittance of the soft key images P21 for the predetermined first time period at Step S112. The soft key images P21 increased in transmittance are displayed in the second region 22 in a translucent manner. Through the above, a part of the list image P11 is visibly displayed in the second region 22 together with the soft key images P21.

At Step S113, the controller 4 measures speed, direction, and distance of the momentum scrolling gesture, calculates speed, direction, and duration of inertial scrolling, and cause inertial scrolling of the list image P11.

After duration of inertial scrolling of the list image P11, the controller 4 then stops inertial scrolling of the list image P11 at Step S114.

Subsequently, the controller 4 gradually reduces the transmittance of the soft key images P21 for the predetermined second time period at Step S115. Once the predetermined second time period elapses, the controller 4 sets the transmittance of the soft key images P21 at 0% and the processing ends. Note that in a situation in which signals for inertial scrolling are additionally input in inertial scrolling, the routine returns to Step S113 and the controller 4 resumes the processing.

The display device 1 according to an embodiment of the present disclosure has been described so far with reference to the drawings. The display device 1 described in the embodiment of the present disclosure is applicable to a device including a display that detects a gesture.

The present embodiment is applicable not only to a smartphone but also a television set and various types of electronic devices having a copy function and a fax function such as a multifunction peripheral, a mobile phone, a personal computer (PC), and a personal data assistance (PDA).

The present disclosure is not limited to the above-described embodiment and can be practiced in various ways within the scope without departing from the essence of the present disclosure.

For example, a display device that can address a scrolling gesture and a momentum scrolling gesture has been described as an example in the embodiment of the present disclosure. However, the present disclosure is applicable to a display device that can address either one of the scrolling gesture and the momentum scrolling gesture.

Furthermore, the controller in the embodiment of the present disclosure displays the second image in a translucent manner by increasing the transmittance of the second image upon detection of a gesture toward the first region. In another embodiment of the present disclosure, the controller scrolls the first image while displaying the second image in a transparent manner by increasing the transmittance of the second image to 100% upon detection of a gesture toward the first region.

The present disclosure is applicable to various types of electronic devices including a display that detects a gesture.

What is claimed is:

1. A display device comprising:
a display surface configured to display an image;
a detector configured to detect a gesture toward the display surface; and
a controller including a processing circuit, the processing circuit being configured to control the image displayed on the display surface based on the gesture detected by the detector through execution of programs stored in a storage section, wherein
the display surface includes a first region and a second region located adjacent to the first region,
the image displayed on the display surface includes a first image located over the first and second regions and a second image located in the second region such as to cover a part of the first image, and
upon the detector detecting the gesture toward the first region, the controller displays the second image in a translucent manner by increasing transmittance of the second image.

2. The display device according to claim 1, wherein
the gesture includes a scrolling gesture of sliding a finger touching the display surface to scroll the first image, and
the controller increases the transmittance of the second image to a specific transmittance and keeps the transmittance thereof at the specific transmittance in course of the detector detecting the scrolling gesture.

3. The display device according to claim 1, wherein
the gesture includes a momentum scrolling gesture to scroll the first image even after a finger touching the display surface is removed from the display surface, and
when the detector detects the momentum scrolling gesture, the controller gradually increases the transmittance of the second image for a predetermined first time period.

4. The display device according to claim 2, wherein
once the controller stops scrolling the first image, the controller reduces the transmittance of the second image.

5. The display device according to claim 2, wherein
once the controller stops scrolling the first image, the controller gradually reduces the transmittance of the second image for a predetermined time period.

6. The display device according to claim 1, wherein
the second image includes a plurality of soft key images,
the soft key images each include a background image, and
the controller changes transmittance of the respective background images.

7. The display device according to claim 5, wherein
once the predetermined time period elapses, the controller sets the transmittance of the second image at 0%.

8. The display device according to claim 2, wherein
the controller reduces the transmittance of the second image to 0% directly after the controller stops scrolling the first image.

9. The display device according to claim 3, wherein
once the controller stops scrolling the first image, the controller reduces the transmittance of the second image.

10. The display device according to claim 3, wherein
when the controller stops scrolling the first image, the controller gradually reduces the transmittance of the second image for a predetermined second time period.

11. The display device according to claim 10, wherein
once the predetermined second time period elapses, the controller sets the transmittance of the second image at 0%.

12. A display device comprising:
a display surface configured to display an image;
a detector configured to detect a gesture toward the display surface; and
a controller including a processing circuit, the processing circuit being configured to control the image displayed on the display surface based on the gesture detected by the detector through execution of programs stored in a storage section, wherein
the display surface includes a first region and a second region located adjacent to the first region,
the image displayed on the display surface includes a scrollable first image located over the first and second regions and a second image located in the second region such as to cover a part of the first image, and
upon the detector detecting the gesture toward the first region, the controller scrolls the first image while causing the display surface to display the second image in a transparent manner by increasing transmittance of the second image up to 100%.
